(19) United States
(12) Patent Application Publication
(10) Pub. No.: US 2008/0025421 A1
(43) Pub. Date: Jan. 31, 2008

(54) Method of Optimizing the Distribution of Transmission Power Between Sub-Channels for Frequency-Division Multiplex Transmission

(75) Inventor: Mohamed Tlich, Lannion (FR)

Correspondence Address: OLIFF & BERRIDGE, PLC, P.O. BOX 320850, ALEXANDRIA, VA, 22320-4850, US

(73) Assignee: FRANCE TELECOM, PARIS (FR)

(21) Appl. No.: 11/587,965

(22) PCT Filed: Apr. 30, 2004
(86) PCT No.: PCT/FR04/01061

§ 371 Date: Dec. 26, 2006

(51) Int. Cl. H04L 27/26

(52) U.S. Cl. 375/260

(57) ABSTRACT

The invention relates to a method of optimizing the distribution of transmission power between sub-channels for transmitting a digital signal in frequency-division multiplex. According to this method, a sub-channel fraction is selected so that, when the transmission power is uniformly distributed between the sub-channels of the selected fraction, the signal-to-noise ratio of each sub-channel of the fraction is greater than a previously-set value.

The present invention relates to a method of optimizing the distribution of transmission power between sub-channels for transmitting a digital signal in frequency-division multiplex.

The invention applies to the field of telecommunications, in which field a channel (a total band of usable frequencies) is frequently divided into sub-channels (sub-bands of frequencies) that are used to transmit the signal in these sub-channels using frequency division multiplexing to increase transmission rate.

The capacity of each sub-channel, i.e. the number of bits that it can code, is linked to the power of the signal sent in that sub-channel. However, the relationship is not linear: each additional bit to be transmitted in the sub-channel necessitates more power than the preceding bit.

Moreover, during transmission, the signal is generally affected by noise, of amplitude that is a function of frequency in particular. Thus each sub-channel is subjected to a different level of noise.

Given these constraints, there is a requirement to distribute the transmission power of the digital signal between the sub-channels so as to optimize the capacity of the channel for a given bit error probability.

The exact calculation of the optimum distribution, for example by the method known as the “Water Filling algorithm” method, is known in the art.

To reduce the complexity of the calculation for determining the optimum distribution, less complex methods are generally used. These methods are less costly in terms of computation time than the Water Filling algorithm, but nevertheless produce a distribution that is close to the optimum distribution.

One of those methods is described in U.S. Pat. No. 5,479,447, according to which a particular transmission power distribution is selected a priori. The constraint of distributing the transmission power uniformly between selected sub-channels is imposed while other sub-channels are not called upon, i.e. no transmission power is allocated to them.

In order to approximate as closely as possible the optimum solution, which maximizes the capacity of the channel, the method then determines which sub-channels should be called upon and which sub-channels must not be called upon.

To this end, the sub-channels are classified in decreasing order of a normalized signal-to-noise ratio calculated on the basis of the same transmission power in each sub-channel.

A fraction of the sub-channels are selected and the transmission power is uniformly distributed between them. More precisely, a certain number of consecutive first sub-channels having the highest normalized signal-to-noise ratios is selected.

The number of first sub-channels forming the selected fraction is obtained iteratively, starting from the first sub-channel, in the order defined above.

On each iteration:
the sub-channel after the sub-channels of the selected fraction, in sub-channel order, is selected and an addition is made to the selected “old fraction” to form a selected “new fraction”;
the transmission power is then distributed uniformly between the sub-channels of the selected new fraction;
the capacity of the channel is calculated for this distribution of the transmission power and compared to the capacity of the channel obtained by distributing the transmission power between the sub-channels of the selected old fraction.

If the capacity of the channel has been increased, the iteration is repeated; if not, it is stopped.

Although simpler than the Water Filling method, the method described in U.S. Pat. No. 5,479,447 still necessitates major operations. In particular, calculating the capacity of the channel for the old fraction and the new fraction on each iteration necessitates recalculating the capacity of each sub-channel.

An object of the invention is to reduce significantly the complexity of the above method.

To this end, the invention consists in a method of optimizing the distribution of transmission power between sub-channels for transmitting a digital signal in frequency-division multiplex, the method being characterized in that a sub-channel fraction is selected. so that, when the transmission power is uniformly distributed between the sub-channels of the selected fraction, the signal-to-noise ratio of each sub-channel of the fraction is greater than a previously-set value.

Accordingly, by means of the invention, only the signal-to-noise ratio of each sub-channel of the selected fraction is compared to the previously-set value.

It is advantageously sufficient to effect this comparison for the sub-channel of the selected fraction with the lowest signal-to-noise ratio. It is then possible to dispense with an iterative method including complex calculations on each iteration.

A method according to the invention may further include one or more of the following features:
the previously-set value depends on a predetermined tolerated noise margin for the sub-channel of the selected fraction with the lowest the signal-to-noise ratio;
the previously-set value is:
   Γₖ(e−1)
   where:
k is an index designating the sub-channel of the selected fraction with the lowest signal-to-noise ratio;
Γₖ is a predetermined tolerated noise margin for the sub-channel k; and
e is the Neper number;
the tolerated noise margin is the same for all the sub-channels;
the following steps are executed:
calculating a normalized signal-to-noise ratio for each sub-channel on the basis of the same transmission power in each sub-channel;
selecting at least the sub-channel with the highest normalized signal-to-noise ratio to form the selected fraction;
repeating the following steps iteratively:
choosing from the sub-channels outside the selected fraction, the sub-channel with the highest normalized signal-to-noise ratio;
if, when the transmission power is uniformly distributed between the sub-channels of the selected fraction and this sub-channel, the signal-to-noise ratio of this sub-channel is greater than the set value, adding this sub-channel to the selected fraction;
else, stopping the iteration;
the following steps are repeated iteratively:
after calculating for each sub-channel a normalized signal-to-noise ratio on the basis of the same transmission power in each sub-channel, choosing from the sub-channels outside the selected fraction, the sub-channel with the highest normalized signal-to-noise ratio;
if, when the transmission power is uniformly distributed between the sub-channels of the selected fraction and this sub-channel, the signal-to-noise ratio of this sub-channel is greater than:

$${Γ}_{n + 1} ( e {\prod }_{k = 1}^{n} \frac{S N R ( k ) + {Γ}_{k}}{S N R ( k ) + {Γ}_{k} ( 1 + \frac{1}{n} )} - 1 ) ,$$

where:
n is the number of sub-channels in the selected fraction;
k is an index corresponding to each of the sub-channels of the selected fraction;
SNR(k) is the signal-to-noise ratio for the sub-channel k, when the transmission power is uniformly distributed between the n sub-channels of the selected fraction;
Γₖ is a predetermined tolerated noise margin for the sub-channel k of the selected fraction;
Γₙ₊₁ is a predetermined tolerated noise margin for this sub-channel n+1; and
e is the Neper number; then adding this sub-channel to the selected fraction;
the method comprises the following final steps:
when the transmission power is uniformly distributed between the sub-channels of the selected fraction, calculating a total number of bits that can be transmitted by all of the sub-channels of the selected fraction;
repeating the following steps iteratively:
for each sub-channel, calculating the additional power necessary for transmitting one additional bit on that sub-channel;
choosing the sub-channel for which the additional power necessary is the lowest;
calculating the distributed transmission power necessary for transmitting the total number of bits in all of the sub-channels plus the additional transmission power of the chosen sub-channel;
if the distributed and augmented transmission power is less than the transmission power, adding one bit to the chosen sub-channel;
else, stopping the iteration;
one bit is added to the chosen sub-channel if, additionally, the power necessary for transmitting all the bits allocated to that sub-channel, including the additional bit, is less than a predetermined maximum power for this sub-channel;
the additional power is calculated only for each sub-channel of the selected fraction.

The invention can be better understood after reading the following description, which is given by way of example only and with reference to the appended drawings, in which:

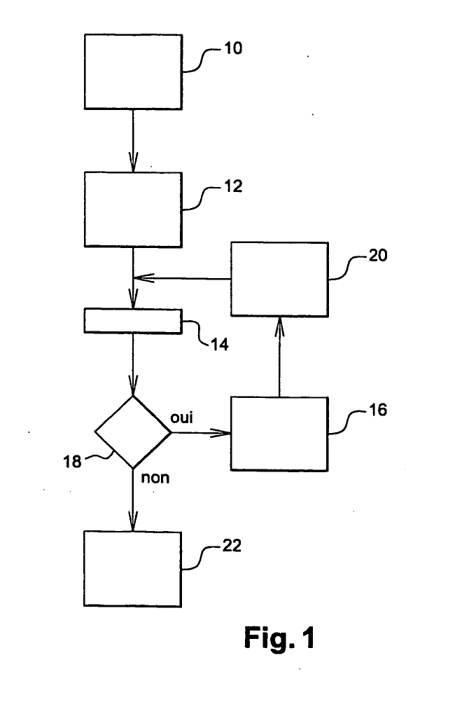

FIG. 1 represents successive steps of a first implementation of a method of the invention;

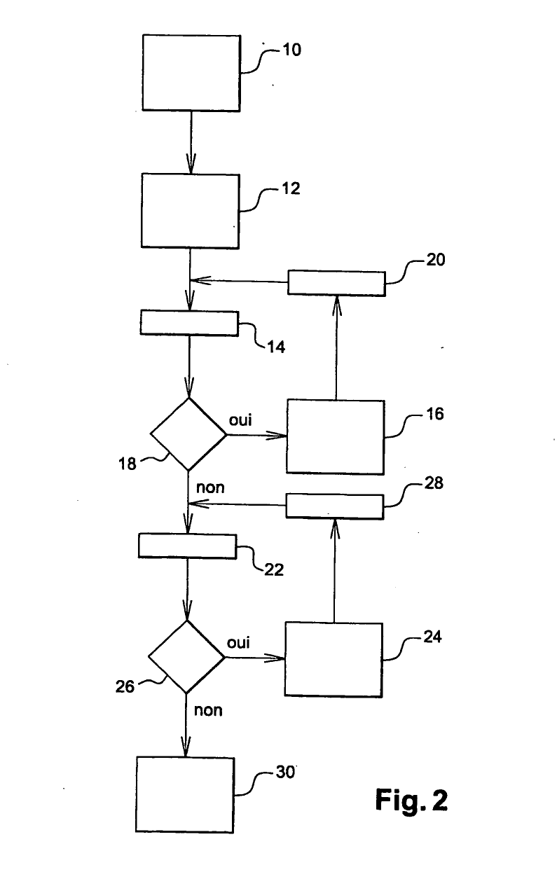

FIG. 2 represents successive steps of a second implementation of a method of the invention;

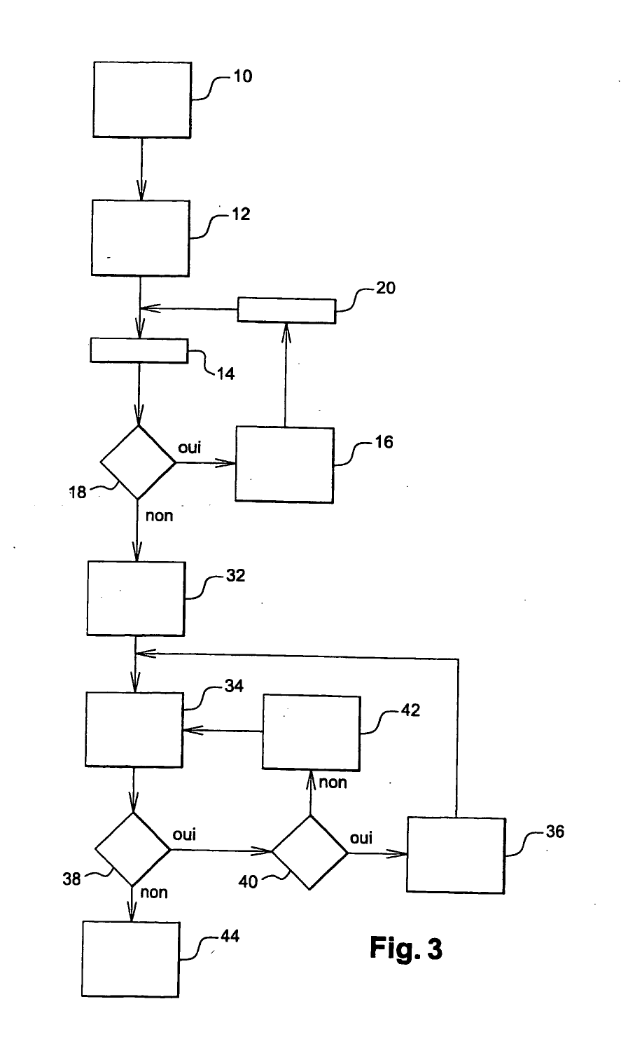

FIG. 3 represents successive steps of a third implementation of a method of the invention.

The capacity of a sub-channel n (the number of bits it can support) is linked to the transmission power and to the noise on the sub-channel, as was demonstrated by Shannon in 1948. Accordingly, subject to the constraint of a noise margin Γₙ for this sub-channel n, the relationship between the number of bits bₙ and the signal-to-noise ratio SNR(n) of the sub-channel n may be written:

$${b}_{n} = {log}_{2} ( 1 + \frac{S N R ( n )}{{Γ}_{n}} ) .$$

To obtain the capacity B of a channel including Nₜₒₜₐₗ sub-channels n, it is then sufficient to sum the number of bits supported by each sub-channel over these Nₜₒₜₐₗ sub-channels, which gives the equation:

$$B = {\sum }_{n = 1}^{{N}_{total}} ( {log}_{2} ( 1 + \frac{S N R ( n )}{{Γ}_{n}} ) ) .$$

Accordingly, the capacity B of the channel is linked to all the signal-to-noise ratios SNR(1) to SNR(Nₜₒₜₐₗ) of the sub-channels, i.e. in particular to the transmission power allocated to each sub-channel.

The requirement is to find a distribution of the transmission power between the sub-channels which, according to the above equation, maximizes the capacity B of the channel.

FIG. 1 represents a method of optimizing the distribution of a transmission power P between sub-channels 1 to Nₜₒₜₐₗ for transmitting a digital signal in frequency-division multiplex.

This method selects a fraction of the sub-channels 1 to N₁ between which the transmission power P is uniformly distributed, with the aim of maximizing the capacity of the channel. In this method, no transmission power is allocated to the other sub-channels N₁+1 to Nₜₒₜₐₗ.

During a first step 10, a standardized signal-to-noise ratio SNR₀(1) to SNR₀(Nₜₒₜₐₗ) is calculated for each sub-channel 1 to Nₜₒₜₐₗ on the basis of the same transmission power p₀ in each of the sub-channels 1 to Nₜₒₜₐₗ.

Also in this first step, the sub-channels 1 to Nₜₒₜₐₗ are ordered in order of decreasing normalized signal-to-noise ratio SNR₀(1) to SNR₀(Nₜₒₜₐₗ). Accordingly, sub-channel 1 is the sub-channel with the highest normalized signal-to-noise ratio SNR₀(1).

The next step is a step 12 during which a selected fraction SNR₀(1) of the sub-channels is initialized by selecting the sub-channel 1 with the highest normalized signal-to-noise ratio. An index n representing the number of sub-channels in the selected fraction is also initialized to 1.

Three steps 14, 16 and 20 are then repeated iteratively, subject to a condition 18 being satisfied.

During the step 14, the sub-channel with the highest normalized signal-to-noise ratio SNR₀(n+1) is selected from the sub-channels n+1 to Nₜₒₜₐₗ outside the selected fraction. Because the sub-channels are in order, this is the channel n+1.

The next step is then a step that tests the condition 18 to determine if, when the transmission power P is uniformly distributed between the sub-channels 1 to n of the selected fraction and this sub-channel n+1, the signal-to-noise ratio SNR(n+1) of the sub-channel n+1 is higher than a previously-set value. That value is selected to be equal to Γₙ₊₁(e−1)where:
Γₙ₊₁, is a predetermined tolerated noise margin for the sub-channel n+1; and
e is the Neper number.

It will be noted that the sub-channel n+1 is the sub-channel whose signal-to-noise ratio SNR(n+1) is the lowest of those of the first n+1 sub-channels for this distribution of the transmission power.

The previously-set value comes from a simplification that is possible of the standard condition of the method described in U.S. Pat. No. 5,479,447, which consists in verifying that the number B(n+1) of bits supported by the channel on iteration n+1 is greater than the number B(n) of bits supported by the channel on iteration n. This condition is equivalent to the following condition:

$${\sum }_{k = 1}^{n + 1} ( {log}_{2} ( 1 + \frac{S N {R}^{′} ( k )}{{Γ}_{k}} ) ) > {\sum }_{k = 1}^{n} ( {log}_{2} ( 1 + \frac{S N R ( k )}{{Γ}_{k}} ) ) , \\ where \text{:}$$

$$S N {R}^{′} ( k ) = \frac{P}{n + 1} S N {R}_{0} ( k ) , and$$

$$S N R ( k ) = \frac{P}{n} S N {R}_{0} ( k ) .$$

It is deduced from this that this standard condition is equivalent to a condition C applying to the signal-to-noise ratio SNR′(n+1) of the channel n+1:

$$S N {R}^{′} ( n + 1 ) > {Γ}_{n + 1} ( {( 1 + \frac{1}{n} )}^{n} ( {\prod }_{k = 1}^{n} \frac{S N R ( k ) + {Γ}_{k}}{S N R ( k ) + {Γ}_{k} ( 1 + \frac{1}{n} )} ) - 1 ) . \\ Noting that {( 1 + \frac{1}{n} )}^{n} < e , and that \\ ( {\prod }_{k = 1}^{n} \frac{S N R ( k ) + {Γ}_{k}}{S N R ( k ) + {Γ}_{k } ( 1 = \frac{1}{n} )} ) < 1 ,$$

we find the value Γₙ₊₁(e−1) that increases the expression:

$${Γ}_{n + 1} ( {( 1 + \frac{1}{n} )}^{n} ( {\prod }_{k = 1}^{n} \frac{S N R ( k ) + {Γ}_{k}}{S N R ( k ) + {Γ}_{k} ( 1 + \frac{1}{n} )} ) - 1 ) .$$

By assuring that the signal-to-noise ratio SNR′(n+1) of channel n+1 is greater than Γₙ₊₁(e−1), the condition C is satisfied a fortiori.

If the condition 18 is satisfied, the next step is the step 16 during which sub-channel n+1 is added to the selected fraction. The value of n is incremented by one unit (step 20) and the process resumes at the step 14.

If the condition 18 is not satisfied, the iteration is stopped.

At the end of the iteration, the result 22 obtained is the selection of a sub-channel fraction 1 to N₁ such that, if the transmission power P is uniformly distributed between the sub-channels 1 to N₁ of the selected fraction, the signal-to-noise ratio SNR(1) to SNR(N₁) of each sub-channel of the fraction is greater than the previously-set value Γ_{N}_{₁}(e−1).

The fraction of sub-channels 1 to N₁ obtained is very close to the solution obtained by the method described in U.S. Pat. No. 5,479,447, by the judicious choice for the value Γ_{N}_{₁}(e−1), which depends on the channel N₁ of the selected fraction with the lowest signal-to-noise ratio.

The tolerated noise margin is preferably the same for all sub-channels and has the value Γ. This further simplifies the method, since the previously-set value is the same on each iteration.

FIG. 2 represents the successive steps of a second implementation of a method of the invention, complementing the implementation described above. The steps common to the first implementation carry the same references and are not described again.

In this second implementation, if the condition 18 is not satisfied, three steps 22, 24 and 28 are repeated iteratively subject to a new condition 26 being satisfied.

The steps 22, 24 and 28 are respectively identical to the steps 14, 16 and 20 described above.

A step of testing the condition 26 executed after the step 22 determines if, when the transmission power P is uniformly distributed between the sub-channels 1 to n of the selected fraction and this sub-channel n+1, the signal-to-noise ratio SNR(n+1) of sub-channel n+1 is greater than a value chosen to equal:

$${Γ}_{n + 1} ( e ( {\prod }_{k = 1}^{n} \frac{S N R ( k ) + {Γ}_{k}}{S N R ( k ) + {Γ}_{k} ( 1 + \frac{1}{n} )} ) - 1 ) ,$$

where:

n is the number of sub-channels in the selected fraction;

k is an index corresponding to each of the sub-channels of the selected fraction;

SNR(k) is the signal-to-noise ratio for the sub-channel k when the transmission power is uniformly distributed between the n sub-channels of the selected fraction;

Γₖ is a predetermined tolerated noise margin for the sub-channel k of the selected fraction;

Γₙ₊₁ is a predetermined tolerated noise margin for sub-channel n+1; and

e is the Neper number.

The choice of this value results from the weighting of

$${( 1 + \frac{1}{n} )}^{n}$$

by e in the expression for the condition C.

At the end of this new iteration, there has thus been selected a fraction made up of the sub-channels 1 to N₂ that is closer than the fraction of sub-channels 1 to N₁ to the solution obtained by the method described in U.S. Pat. No. 5,479,447, or even equal to that condition if the number N₂ of sub-channels is sufficiently large for

$${( 1 + \frac{1}{{N}_{2}} )}^{{N}_{2}}$$

to be very close to e. In general, this is true if N₂ exceeds 30.

FIG. 3 represents a string of steps of a third implementation of a method of the invention, also complementing the first implementation described above. Steps common to the first implementation carry the same references and are not described again.

In this third implementation, if the condition 18 is not satisfied, the next step is a step 32 which calculates the N₁ numbers of bits b₁ to b_{N}_{₁} that can be transmitted by all of the sub-channels 1 to N₁ of the selected fraction if the transmission power P is uniformly distributed between the sub-channels 1 to N₁.

The steps 34 and 36 are then repeated for as long as two conditions 38 and 40 are satisfied.

In the step 34, an additional power Δp₁ to Δp_{N}, necessary for transmitting an additional bit on each sub-channel is calculated for sub-channels 1 to N₁ of the selected fraction and the channel k of the selected fraction for which necessary power Δpₖ is the lowest of these necessary powers Δp₁ to Δp_{N}_{₁} is chosen.

The condition 38 imposes verifying that adding the necessary additional power Δpₖ is possible, given the available transmission power P. To this end it is verified that the sum of the transmission powers allocated to the sub-channels 1 to N₁ after this addition is still lower than the available transmission power P.

The condition 40 imposes verifying that adding the necessary power Δpₖ is possible for the sub-channel k. This verifies that the transmission power pₖ+Δpₖ allocated to the channel after this addition is less than a maximum power Pₖ available for this sub-channel, called the power mask.

If these two conditions 38 and 40 are satisfied, the next step is a step 36 during which the transmission power Δpₖ necessary for transmitting an additional bit is added to the power allocated to the sub-channel k and a bit is added to the chosen sub-channel k. The next step is then the step 34.

If the condition 40 is not satisfied but the condition 38 is satisfied, additional power can no longer be allocated to the chosen sub-channel k. In order to ignore this sub-channel when calculating the necessary power Δp₁ to Δp_{N}, it is removed from the list 1 to N₁ in a step 42.

Finally, if the condition 38 is no longer satisfied, the result 44 obtained consists of the transmission powers p₁ to p_{N}, to be allocated to the sub-channels 1 to N₁ and the numbers of bits b₁ to b_{N}_{₁} supported by each of these sub-channels 1 to N₁.

Another approach is, during steps 34 to 42, to work on all the sub-channels 1 to N instead of the sub-channels 1 to N₁. The result 44 then obtained consists in the transmission powers p₁ to p_{N} to be allocated to the sub-channels 1 to N₁ and the numbers of bits b₁ to b_{N}_{₁} supported by each of the sub-channels 1 to N₁. This alternative is advantageous only if there is no power mask associated with each of the sub-channels. The additional power necessary for transmitting a bit on a sub-channel outside the selected fraction is generally higher than the power mask associated with that sub-channel.

Note that the invention is not limited to the implementations described.

In particular, the additional steps of the third implementation may be carried out after the steps of the second implementation.

Furthermore, other values may be employed for the test steps specific to the first and second implementations. In particular, the condition described in U.S. Pat. No. 5,479,447, i.e. the condition 26, may be used as a condition specific to the second implementation of the invention.

1-9. (canceled)

10. A method of optimizing the distribution of transmission power between sub-channels for transmitting a digital signal in frequency-division multiplex, the method comprising:
a step of calculating a normalized signal-to-noise ratio for each sub-channel on the basis of the same transmission power in each sub-channel;
a step of selecting at least one sub-channel with a normalized signal-to-noise ratio that is greater than a previously-set value so as to form a sub-channel fraction referred to as a selected fraction;
the method being characterized in that if the normalized signal-to-noise ratio of a sub-channel outside the selected fraction is greater than said previously-set value, the method includes a step during which said sub-channel is added to the selected fraction.

11. A method according to claim 10 for optimizing transmission power, comprising:
during the selection step, selecting the sub-channel with the highest normalized signal-to-noise ratio; and
repeating the following steps iteratively:
choosing from the sub-channels outside the selected fraction, the sub-channel with the highest normalized signal-to-noise ratio;
if, when the transmission power is uniformly distributed between the sub-channels of the selected fraction and this sub-channel, the signal-to-noise ratio of this sub-channel is greater than the set value, adding this sub-channel to the selected fraction; else, stopping the iteration.

12. A method according to claim 10 for optimizing transmission power, wherein the previously-set value depends on a predetermined tolerated noise margin for the sub-channel of the selected fraction with the lowest signal-to-noise ratio.

13. A method according to claim 12 for optimizing transmission power, wherein the previously-set value is:
Γₖ(e−1)
where:
k is an index designating the sub-channel of the selected fraction with the lowest signal-to-noise ratio;
Γₖ is a predetermined tolerated noise margin for the sub-channel k; and
e is the Neper number.

14. A method according to claim 13 for optimizing transmission power, wherein the tolerated noise margin is the same for all the sub-channels.

15. A method according to claim 10 for optimizing transmission power, wherein the following steps are repeated iteratively:
after calculating for each sub-channel a normalized signal-to-noise ratio on the basis of the same transmission power in each sub-channel, choosing from the sub-channels outside the selected fraction, the sub-channel with the highest normalized signal-to-noise ratio;
if, when the transmission power is uniformly distributed between the sub-channels of the selected fraction and this sub-channel, the signal-to-noise ratio of this sub-channel is greater than:
$${Γ}_{n + 1} ( e {\prod }_{k = 1}^{n} \frac{S N R ( k ) + {Γ}_{k}}{S N R ( k ) + {Γ}_{k} ( 1 + \frac{1}{n} )} - 1 ) ,$$
where:
n is the number of sub-channels in the selected fraction;
k is an index corresponding to each of the sub-channels of the selected fraction;
SNR(k) is the signal-to-noise ratio for the sub-channel k, when the transmission power is uniformly distributed between the n sub-channels of the selected fraction;
Γₖ is a predetermined tolerated noise margin for the sub-channel k of the selected fraction;
Γₙ₊₁ is a predetermined tolerated noise margin for this sub-channel n+1; and
e is the Neper number.

16. A method according to claim 10 for optimizing transmission power, comprising the following steps:
when the transmission power is uniformly distributed between the sub-channels of the selected fraction, calculating a total number of bits that can be transmitted by all of the sub-channels of the selected fraction;
repeating the following steps iteratively:
for each sub-channel, calculating the additional power necessary for transmitting one additional bit on that sub-channel;
choosing the sub-channel for which the additional power necessary is the lowest;
calculating the distributed transmission power necessary for transmitting the total number of bits in all of the sub-channels plus the additional transmission power of the chosen sub-channel;
if the distributed and augmented transmission power is less than the transmission power, adding one bit to the chosen sub-channel;
else, stopping the iteration.

17. A method according to claim 10 for optimizing transmission power, wherein one bit is added to the chosen sub-channel if, additionally, the power necessary for transmitting all the bits allocated to that sub-channel, including the additional bit, is less than a predetermined maximum power for this sub-channel.

18. A method according to claim 17 for optimizing transmission power, wherein the additional power is calculated only for each sub-channel of the selected fraction.
